(19) United States
(12) Patent Application Publication
(10) Pub. No.: US 2019/0334698 A1
(43) Pub. Date: Oct. 31, 2019

(54) INCENTIVIZED DECENTRALIZED AUGMENTED REALITY

(71) Applicant: General Electric Company, Schenectady, NY (US)

(72) Inventor: Baljit SINGH, Schnectady, NY (US)

(21) Appl. No.: 15/966,732

(22) Filed: Apr. 30, 2018

(51) Int. Cl. H04L 9/06; H04L 29/08; G06Q 20/06; G06Q 20/38; G06T 19/00

(52) U.S. Cl. CPC H04L 9/0637; H04L 67/125; H04L 67/10; H04L 2209/38; G06Q 20/3829; G06T 19/006; H04L 2209/56; G06Q 20/0658

(57) ABSTRACT

According to some embodiments, a system and method are provided, comprising: detecting, with a resource sharing module at a first Internet of Things (IoT) device, a second device; determining one or more first data elements to transfer from the first IoT device to the second device; determining one or more second data elements to transfer from the second device to the first IoT device; transmitting the one or more first data elements from the first IoT device to the second device; transmitting the one or more second data elements from the second device to the first IoT device; establishing, between the first IoT device and the second device, a common transformation to apply to the one or more first and second data elements; applying the common transformation to the one or more first and second data elements to generate a transformed data element; and recording the common transformation via a secure, distributed transaction ledger. Numerous other aspects are provided.

### BACKGROUND

Augmented reality (AR) is a direct or indirect live view of a physical real-world environment whose elements are “augmented” by computer-generated perceptual information. This augmentation may be across multiple sensory modalities, including visual, auditory, haptic, somatosensory and olfactory. The overlaid sensory information may be constructive (i.e. additive to the natural environment) or destructive (i.e., masking of the natural environment) and may be spatially registered with the physical world such that it is perceived as an immersive aspect of the real environment. AR functionality may be experienced by a user and accessed via a user device. Often AR applications may be compute intensive and may therefore use a lot of power, which may result in heavy user devices. Additionally, the devices often do not share data with each other, even when two or more devices are co-located.

It would be desirable to provide systems and methods to improve AR functionality.

### SUMMARY

According to some embodiments, a method may include: detecting, with a resource sharing module at a first Internet of Things (IoT) device, a second device; determining one or more first data elements to transfer from the first IoT device to the second device; determining one or more second data elements to transfer from the second device to the first IoT device; transmitting the one or more first data elements from the first IoT device to the second device; transmitting the one or more second data elements from the second device to the first IoT device; establishing, between the first IoT device and the second device, a common transformation to apply to the one or more first and second data elements; applying the common transformation to the one or more first and second data elements to generate a transformed data element; and recording the common transformation via a secure, distributed transaction ledger.

According to some embodiments, a system may include: a resource sharing module; a memory storing processor-executable steps; and a resource sharing processor coupled to the memory, and in communication with the resource sharing module and operative to execute the processor-executable steps to cause the system to: detect at a first Internet of Things (IoT) device, a second device; determine one or more first data elements to transfer from the first IoT device to the second device; determine one or more second data elements to transfer from the second device to the first IoT device; transmit the one or more first data elements from the first IoT device to the second device; transmit the one or more second data elements from the second device to the first IoT device; establish, between the first IoT device and the second device, a common transformation to apply to the one or more first and second data elements; apply the common transformation to the one or more first and second data elements to generate a transformed data element; and record the common transformation via a secure, distributed transaction ledger.

According to some embodiments, a non-transitory computer-readable medium stores program code executable by a computer system to cause the computer system to: detect at a first Augmented Reality (AR) device, a second device; determine one or more first data elements to transfer from the first AR device to the second device; determine one or more second data elements to transfer from the second device to the first AR device; transmit the one or more first data elements from the first AR device to the second device; transmit the one or more second data elements from the second device to the first AR device; establish, between the first AR device and the second device, a common transformation to apply to the one or more first and second data elements; apply the common transformation to the one or more first and second data elements to generate a transformed data element; and record the common transformation via a secure, distributed transaction ledger.

Technical effects of some embodiments of the invention may include improved and computerized ways to efficiently and accurately facilitate sharing of data and resources between Internet of Things (IoT) devices, especially augmented reality devices. As embodiments provide for devices to be dynamically configured to share resources, no single device needs to be as powerful (and in terms of wearable devices, as heavy); but collectively the devices create a powerful system. Another technical effect of some embodiments of the invention may include block chain technology to help synchronize information among a plurality of devices. Still another technical effect of some embodiments of the invention includes the decentralization and localization of storage, services, and payments. As each element (e.g., device, agent, thing) independently and dynamically offers its own services, in one or more embodiments, the services are local. Local services may result in faster response time for rendered services, data transfers, etc. Additionally, devices may own their data in embodiments; therefore, there may be no need to create a centralized database. Devices owning their data may also eliminate the load on cellular networks, since most of the data may be transferred between devices directly. Embodiments may provide a unified protocol for sharing data between devices, with the technical effect of providing seamless sharing. Conventionally, on the other hand, the systems in different devices may not be compatible with each other. For example, both Microsoft HoloLens® and iRobot Roomba® scan and/or build three-dimensional (3D) maps of rooms, but they do not “talk” to one another. Another technical effect of some embodiments may include a democratized economy of machines where devices pay one another for services. As such, some devices may be profitable and this may encourage others to contribute and offer devices that share data resources. Additionally, different quality and/or levels of services may be offered for different returns.

With these and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### BRIEF DESCRIPTION OF THE DRAWINGS

FIG. 1 is a high-level block diagram of a system according to some embodiments.

FIG. 2 is a method of verifying industrial data in accordance with some embodiments.

FIG. 3 is a non-exhaustive example of data sharing according to some embodiments.

FIG. 4 is a system implementing a digital transaction with blockchain according to some embodiments.

FIG. 5 is a distributed ledger reference architecture according to some embodiments.

FIG. 6 illustrates a platform according to some embodiments.

### DETAILED DESCRIPTION

For AR devices, spatial mapping and spatial inference may be fundamental aspects. While conventional cellular devices use Global Positioning Systems (GPS) or WiFi based positioning for location-based applications, these techniques may not work well indoors or may require additional context (e.g., computer vision, indoor positioning systems, supported by, for example, object recognition, 3D positioning, and acoustic mapping). AR devices may use simultaneous localization and mapping (SLAM) (e.g., constructing or updating a map of an unknown environment while simultaneously keeping track of an agent's location within it) for spatial mapping and self-positioning. For example, a device may use SLAM for displaying a digital box on top of a real table. However, SLAM and other geometric processing processes may be compute intensive (e.g., require high performant processors (e.g., large CPUs) that need large power supplies, which in turn may lead to large batteries). This may be problematic as it may lead to heavier and less ergonomic wearable AR devices. Additionally, if two or more IoT devices are co-located, they may infer on the same physical space. As used herein, “co-located” refers to being physically in the same environment (e.g., the same room). Conventionally, instead of sharing the workload, these devices may duplicate the mapping effort and waste resources. Moreover, this independent mapping effort may lead to each device's positioning being independent of another, thereby increasing the difficulty in creating co-located shared experiences for multiple users.

One or more embodiments provide for an incentivized peer-to-peer resource sharing system for IoT devices. As used herein, an IoT device is any physical device embedded with connectivity which enables the device to connect and exchange data with other IoT devices.

Embodiments may provide a consensus-based system, where if multiple devices in a same environment agree upon information, that agreed-upon information may be recorded and shared using an open, distributed ledger.

Embodiments may use an open, distributed ledger, such as a block chain, that can record transactions between two or more devices efficiently, and in a verifiable and permanent way, to unite information flowing between different devices. Blockchain-based cryptocurrency and ratings may be used to encourage sharing and fairness.

In one or more embodiments, a resource sharing module provides for two or more IoT devices to share data content and create a shared environment. For example, if two users are planning a surgery, embodiments may provide for both users to collaborate and look at the same thing (e.g., both users see the shared scan of the patient and may walk through the surgery). Some embodiments provide for devices to seamlessly share data and transfer currency for shared services. One or more embodiments may use block chains (e.g., a continuously growing list of records referred to as “blocks,” which are linked and secured using cryptography) to effect data transfer in the AR space. Each block in the chain may include a cryptographic hash of the previous block, a timestamp and transaction data.

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “automatically” may refer to, for example, actions that may be performed with little or no human interaction.

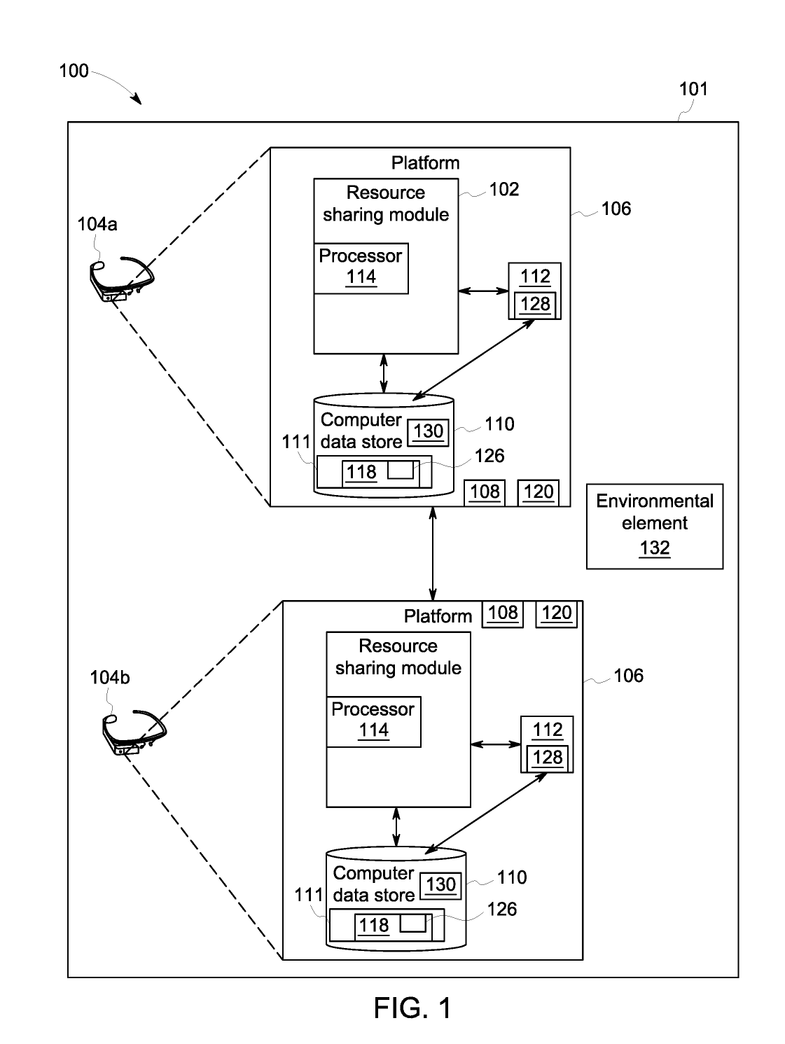

FIG. 1 is a high-level block diagram of a system 100 according to some embodiments in which a resource sharing module 102 may be implemented, arranged in accordance with at least one embodiment described herein. FIG. 1 represents a logical architecture for describing processes according to some embodiments, and actual implementations may include more or different components arranged in other manners.

In particular, the system 100 may include two or more IoT devices 104a, 104b. While the examples described herein may focus on an AR device as the type of IoT device, any suitable IoT device (e.g., robotic vacuum cleaner, connected light bulb or sensor, smoke detector, etc.) may be used. While two devices 104 are shown herein, any suitable number may be used. It is noted that each device 104 communicates with each other in a same manner, as described below. Each device 104 may include a data sharing platform 106 with at least one communication port 108 to receive a stream of data from other devices 104 and any device with a compatible port.

In some embodiments, the platform 106 may include a computer data store 110 that may receive and store data 111 from other devices and other components of the system 100. The computer data store 110 may also provide information to the resource sharing module 102 and store results from the resource sharing module 102.

The data store 110 may comprise any one or more systems that store data that may be used by the module and/or platform. The data stored in data store 110 may be received from disparate hardware and software systems associated with the devices 104, some of which are not inter-operational with one another, as well as from the environment 101. The data may be pushed to data store 110 and/or provided in response to queries received therefrom.

In one or more embodiments, the data store 110 may comprise any combination of one or more of a hard disk drive, RAM (random access memory), ROM (read only memory), flash memory, etc. The data store 110 may store software that programs a processor 114 and the resource sharing module 102 to perform functionality as described herein.

The data store 110 may support multi-tenancy to separately support multiple unrelated clients by providing multiple logical database systems which are programmatically isolated from one another.

The data may be included in a relational database, a multi-dimensional database, an eXtendable Markup Language (XML) document, and/or any other structured data storage system. The physical tables of data store 110 may be distributed among several relational databases, multi-dimensional databases, and/or other data sources. The data of data store 110 may be indexed and/or selectively replicated in an index.

The data store 110 may be implemented as an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data 111 comprises one or more of conventional tabular data, row-based data stored in row format, column-based data stored in columnar format, time series data in a time series data store, and object-based data.

The data sharing platform 106 may utilize a secure, distributed ledger 112 to verify information received at the resource sharing module 102 and then mark the stored data as “valid” so that it can be safely used by the platform 106. As described further below, the validity in a secure, distributed ledger (e.g., block-chain) may be derived from the consensus.

According to some embodiments, the data store 110 stores electronic records defining the received data 111. According to some embodiments, the resource sharing module 102 and/or other elements of the system may then record information about various transactions using the secure, distributed ledger 112 (e.g., via a block chain verification process). For example, the resource sharing module 102 may record a date and time, hash value, etc. via the secure distributed ledger 112 in accordance with any of the embodiments described herein.

The data sharing platform 106 may be, for example, associated with any IoT device, a Personal Computer (“PC”), laptop computer, a tablet computer, a smartphone, and/or a database or similar storage devices.

The resource sharing module 102 may include one or more processing elements 114. The processor 114 may, for example, be a conventional microprocessor, and may operate to control the overall functioning of the resource sharing module 102. In one or more embodiments, the processor 114 may be programmed with a continuous or logistical model of processes used by the device.

As used herein, devices, including those associated with the platform 106 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet, Transmission Control Protocol (“TCP”), User Datagram Protocol (“UDP”), Hypertext Transfer Protocol (“HTTP”); and/or a middleware protocol such as ZeroMQ or MQTT. Note that any devices described herein may communicate via one or more such communication networks.

The resource sharing module 102, according to some embodiments, may access the data store 110 and utilize rules and logic 116 and processing elements 114 to share and distribute a data element 118 to another device 104. In one or more embodiments, the data element 118 may be transmitted to a platform of the other device 104 for use by the other device, as appropriate (e.g., for display, manipulation, etc.).

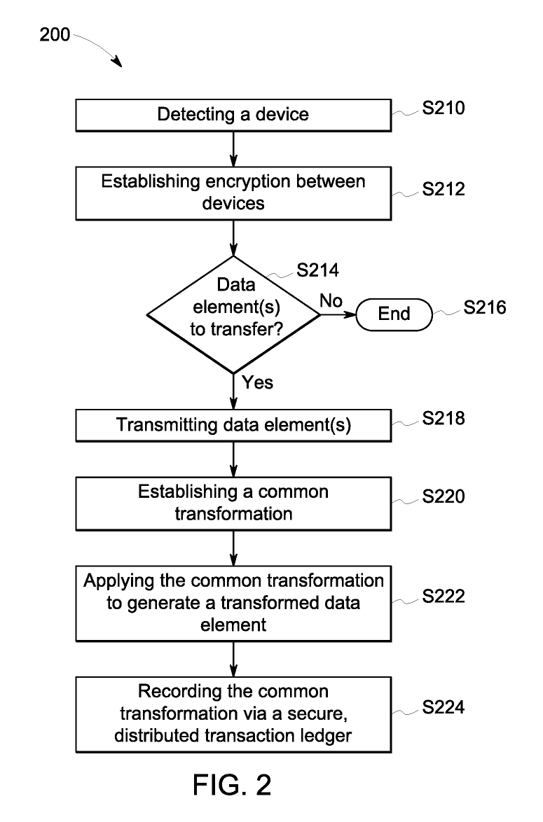

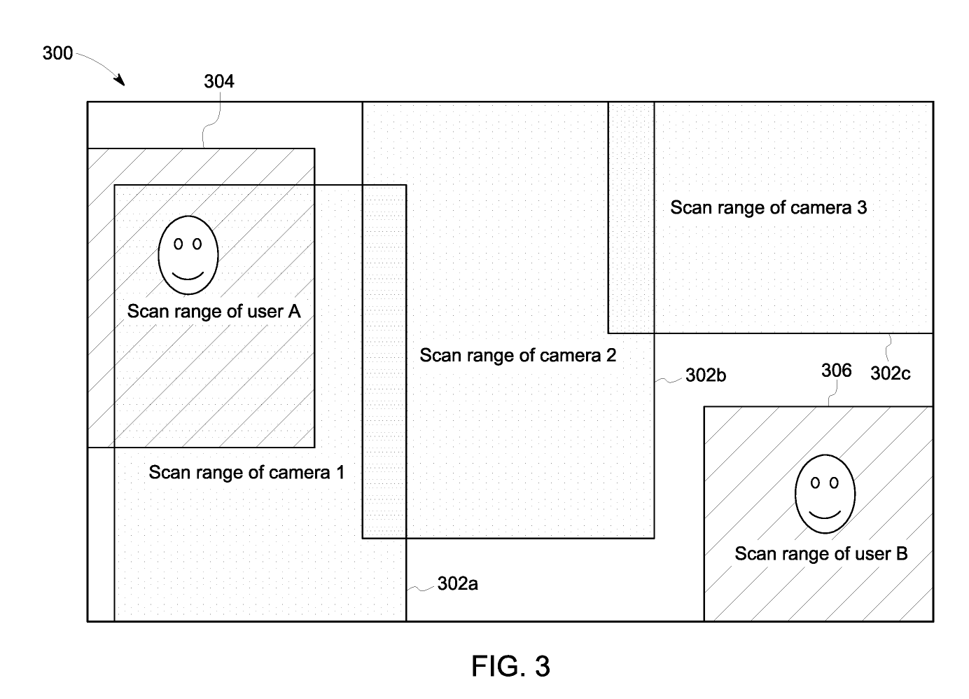

Turning to FIGS. 2-3, a flow diagram and associated block diagram, of an example of operation according to some embodiments is provided. In particular, FIG. 2 provides a flow diagram of a process 200, according to some embodiments. Process 200, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

Initially, at S210, a first device 104a detects a second device 104b in a same environment 101 such that the first device 104a and the second device 104b are co-located. In one or more embodiments the first device 104a and the second device 104b may be the same (e.g., both the same AR device) or different types and versions of devices (e.g., one AR device and one robotic vacuum; or one AR device manufactured by Company X and one AR device manufactured by Company Y). In one or more embodiments, each of the devices may be one of a static agent and a dynamic agent. In one or more embodiments the static agent is a device having a fixed position (e.g., wall/ceiling mounted: color and depth cameras, sensors, lights, smoke/carbon monoxide detectors, etc.), while the dynamic agent is a mobile device (e.g., all wearable devices, including AR devices, any robots or drones that contribute in the system, etc.).

In embodiments, a polling mechanism 120 at the first device 104a may send out a request looking for other devices (e.g., “detection message” 113), and when the second device 104b receives the request, the second device 104b may send a response 115 back to the first device 104a to establish communication. In one or more embodiments, the first device 104a and second device 104b may directly communicate with each other (e.g., Bluetooth, IP-protocol, etc.), or may communicate with each other through a central access point (e.g., WiFi). In some embodiments, a mechanism other than a polling mechanism may allow the first device 104a to discover the second device 104b.

Then in S212 encryption is established between the first device 104a and the second device 104b. In one or more embodiments, the encryption may be via a secondary message, distinct from the detection message. In one or more embodiments, the encryption may be asymmetric such that the first device 104a and the second device 104b share a public key and each keeps a separate private key. Then the data may be encrypted before transmission and only a private key may decrypt the data. It is noted that by encrypting the data, other devices in the environment 101 may not access the data without permission. It is noted that the encryption may be optional.

Next, in S214, it is determined if one or more data elements 118 may be transferred between the first device 104a and the second device 104b. As used herein, the terms “data element” and “resource element” may be used interchangeably. As described above, the data elements may be any suitable data that may be transferred between devices (e.g., spatial maps, audio data, video data, core-temperature data, etc.). As a non-exhaustive example described herein, the data elements may involve at least a portion of a spatial map used by AR devices.

In some embodiments, the first device 104a may broadcast a message 122 to the second device 104b including one or more first data elements 118a available from the first device 104a. In response to receipt of the broadcast message at the second device 104b, the second device 104b may transmit a broadcast response message 124 to the first device 104a. The broadcast response message 124 may include one or more second data elements 118b available from the second device 104b in exchange for one or more specified first data elements 118a. In other embodiments, the first device 104a may broadcast a message 122 to the second device 104b including one or more second data elements 118b the first device 104a requests to receive from the second device 104b. In response to receipt of the broadcast message from the first device 104a, the second device 104b may transmit a broadcast response message 124 to the first device 104a including an indication that the one or more second data elements 118b are available. The broadcast response message 124 may also include a request for one or more first data elements 118a from the first device 104a in exchange for the one or more second data elements 118b from the second device 104b.

In one or more embodiments, data permissions may be established when sharing data elements, such that a device may be authorized to share certain data elements (e.g., a partial sharing) with some devices and not with others. For example, in an industrial environment, some device users may be authorized to access all of the data elements, while other device users may only be authorized to access a minimum amount of data elements. In one or more embodiments, the permissions may be recorded in a secure distributed transaction ledger 112 (e.g., blockchain) to enable a seamless sharing between devices in a permission-use environment.

It is noted that in embodiments, the first device 104a and the second device 104b may transmit messages back and forth in determining which data elements 118a, 118b may be available. As a non-exhaustive example, there may be more than two devices trying to request data elements, and a third device may note that the first device has only two of three requested data elements available, while the second device has all three requested data elements; the third device may execute the exchange with the second device instead of the first device.

In some embodiments, the first device 104a and the second device 104b may the same devices, may be different types of devices (e.g., AR device and robotic vacuum), or may be the same type of device made by different manufacturers (e.g., GoogleGlass® and Hololens®), which may use a standardized common data model to communicate with each other (e.g., with videos, ×264 is the standard compression to share videos over the internet). When the first device 104a and the second device 104b are determining whether the data elements may be exchanged, the format of the data element may be included in the determination. For example, both of the devices may share data elements in a common format, or one of the devices may indicate the available data element is in a particular format, and it is up to the receiver device whether they want to continue the exchange. After the exchanged data is received, it may be stored in the received format, or processed to any other suitable format.

It is further noted that while the examples herein may describe exchanging first data elements 118a for second data elements 118b, the data elements may instead, or in addition, be exchanged for crypto-currency. In one or more embodiments, each device 104 may include one or more rules 116 for exchanging data. For example, a device may value its data elements as being worth a certain Bitcoin®, or other cryptocurrency, or value for each byte or other volume of resource element data. As another example, if each exchange is assumed equal, the monetary value of payment would be the same, and the net sum is zero. One or more embodiments may use an independent incentivization (i.e. crypto-currency) to allow for asymmetric device-usage, where devices may be dominantly producers or consumers.

In one or more embodiments, the data elements 118a, 118b may also include a quality rating 126 that may be factored into the exchange. As two interacting devices may have different ratings, sharing data elements between them may result in a nonzero net sum (e.g., low rating devices may pay high rating devices, but only for the different in their quality). As a non-exhaustive example, a signal to noise ratio may be used to assign a quality value, where the greater the noise, the lower the quality of data. Other suitable metrics may be used, based in part on the data type. In one or more embodiments, the devices may rate the data elements, agree on a quality rating 126, and then this quality rating 126 may be recorded via a secure, distributed transaction ledger (e.g. block chain) 112 as a block 128 in a quality block chain that tracks the quality rating 126. In one or more embodiments, the blocks 128 may create a historical quality block chain for each device. As such, each device may have an overall rating score that may be used to determine the device's quality of sharing. If, for example, a device engages in malpractice (e.g., receiver refuses to pay after receiving a data element; a sender floods the system with poor quality data maps to obtain payment), the device may have a low-quality rating 126. The quality rating 126 may be agreed upon by the devices in the exchange, and be based on historic behavior of the device. In one or more embodiments, the rating may occur prior to the transaction or after the transaction.

In one or more embodiments, the value of a device's quality rating 126 may determine the amount of payment it charges. It is noted that as ratings may be directly tied to a monetary value, good practices may be encouraged and/or incentivized. The inventor notes that a result may be that high-quality devices may start accumulating wealth/generating revenue; while low-quality devices may incur debt. When the generated revenue is higher than the cost of operation of the device, the device may become profitable. When the device incurs debt, the debt may be manifested as subscription or service costs for using the device. It is noted that as static devices are fixed, they may have better processing/hardware and be more likely to be high quality devices; while mobile devices may have a lower rating due to hardware constrains.

One or more embodiments may include a tiered quality model where the device may share lower quality data elements at low or no cost, while reserving high quality data elements for premium cost.

In one or more embodiments, each resource sharing module 102 may use machine learning to optimize the best exchange rules 116. For example, if the resource sharing module 102 knows that Joe typically spends more crypto-currency in the afternoon, and he has already spent half of his currency by 11 am, the resource sharing module 102 may begin picking less expensive options with regard to resource elements (e.g., less information, less quality, etc.).

Turning back to the process 200, if the first device 104a and the second device 104b agree to an exchange, the exchange is approved and the process 200 proceeds to S218. If the first device 104a and the second device 104b do not approve the exchange, the process ends in S216.

In S218, the data elements 118a, 118b may be transmitted from the first device 104a and second device 104b, respectively, to the second device 104b and first device 104a. In one or more embodiments, the transmitted data elements 118a,118b may be raw data or may be pre-processed by the device prior to transmission. Continuing with the spatial map data elements example described above, the raw data may be all of the point clouds scanned using respective sensors; and the pre-processed data element may be a simplified map/model or object detection. If, for example, the data element was a video, pre-processing of the video may include data compression.

In the spatial map example, both the first device 104a and the second device 104b may exchange a model of the environment e.g., detected simple planes in a geographical area (e.g., walls and flat surfaces).

After the exchange, both the first device 104a and the second device 104b may each have two sets of data elements: 1. any self-generated/previously received data elements and 2. the received data elements 130. In one or more embodiments, there may be overlap between the two sets of data elements. For example, with respect to the spatial maps, each set may include the same portion of the environment 101.

Returning to the process 200, in S216 a common geometric transformation to apply to the exchanged resource elements 130a, 130b may be established between the first device 104a and the second device 104b. In one or more embodiments, the resource sharing module 203 at each respective device 104a, 104b may point register the received data elements 130a, 130b with the self-generated/previously received data elements to account for the overlap, such that the devices 104a, 104b are co-processing the data elements. With point registration of the two sets of data elements, the resource sharing modules 102 may determine a particular geometric transformation may be applied to the data elements that results in a similar point registration at the first device 104a and the second device 104b. In one or more embodiments, the point registration and/or geometric transformation may be used with spatial mapping/geometrical processing. The geometric transformation may include triangulation or any other suitable geometric transformation.

Then in S220, the common transformation is applied to the first transmitted elements 130a and the second transmitted elements 130b, respectively to generate a transformed resource element.

With respect to the spatial maps example, the resource sharing module 102 at each respective device 104a, 104b may analyze both maps (self-generated and received) independently to determine their location on the map relative to each other and environmental elements 132 (e.g., a table, door, etc.). The resource sharing module 102 at each respective device 104a, 104b may then determine and establish between them a same transformation to apply to both maps to generate a single map, such that each device is viewing the same map. A benefit of this sharing of data is that each device may have less work. For example, when both the first device 104a and the second device 104b are working from the same map, when new data is received at the first device 104a, and the first device 104a shares the new data with the second device 104b, the second device 104b knows the orientation of the new data, and may generate the new data on the map in a proper location, without the second device 104b having to go to that new data location to obtain the data for itself. It is also noted that a third device, for example, may request data elements from the first and second devices without doing the work to generate the data elements.

Next, in S222, the transformation used to generate the transformed data element may be recorded via a secure, distributed transaction ledger (e.g., blockchain) 112 and the transformation is stored at each of the first device 104a and the second device 104b. If no other blocks exist in the chain, the transformation may be the first item in the block. In one or more embodiments, cryptography may be overlaid onto each of the blocks.

Turning to FIG. 3, a non-exhaustive example is provided according to some embodiments. With respect to AR devices, environment building may be a highly parallel task, where conventional different devices may spend time and energy costs to rebuild a map of a new environment from the beginning. Embodiments may provide for the first device to discover there is already a second device in that environment with a map, and the first device may engage in an exchange with the second device to obtain the map for a fraction of what it would cost the first device to generate the map from the beginning.

The environment 300 includes first, second and third, static devices 302a, 302b, 302c (e.g., cameras) that may scan and capture the environment 300 as a point cloud. The static devices 302 may be constantly capturing their part of the environment (e.g., partial map) using any suitable techniques (e.g., plane finding, object recognition, proximity, etc.). The static devices 302 may transform the point cloud into a compressed model. In one or more embodiments, each static device 302 may share its compressed model of the partial map with the other static devices 302, as in S216. Using any suitable feature registration technique (overlaps between maps), each static device 302 may determine the transform to apply between each other, as in S216. When the static devices 302 agree upon the relative transformation and apply the transformation as in S220, a block may be issued of the transformation and added to the block chain, as in S222. It is noted that the transformation is created by the devices themselves, and the devices come to a common conclusion to share the transformation via blockchain. The block may include the information about the device, and their relative transform. The block may also include the locations of the identified features/objects. This sharing and block issuance may create clusters of devices/nodes that share with one another. In one or more embodiments, any time a cluster is changed or the transform is updated, a new block may be issued and recorded.

Continuing with the example, a new user, User A enters the environment 300 wearing a User A AR device 304. The AR device 304, similar to the static devices 302, begins scanning its environment 300 to create a map. Given its proximity to the first static device 302a, the User A AR device 304 may request the first static devices' 302a existing blockchain and may then discover the cluster. The User A AR device 304 may then exchange maps with all of the static devices 302a, b, c. Just like the static devices 302, the User A AR device 304 may contribute in generating maps and issuing blockchains. In embodiments, in addition to the map it has received from the first static device 302a, the User A AR device 304 may also access the transformed map from the other static devices 302b, c, and may use them for map generation or any other processing, without the cost of generating it from the beginning. It is noted that each static device has a different map because while each static device is applying the same transformation, they are applying the transformation to different data. In one or more embodiments, the User A AR device may also receive the transformation.

Next, User B having another device 306 enters the environment 300. However, since User B's device 306 does not share any interaction with the existing static devices 302a, b, c or User A's AR device 304, User B's device 306 exists in its own isolated environment. However, if User B's device 306 were to move into a common area (indicated herein by the shaded overlapping regions) of the environment, User B's device 306 may follow the same process as User A's AR device 304, described above. It is noted that the devices that remain in the environment 300 do not have to be static. For example, the devices may be placed on a drone or a robot whose job it is to move around the environment 300 and capture data.

In some embodiments, static agents may be part of the infrastructure and not moving around (e.g., a sensor in a fixed location that may be constantly scanning, or the camera described above in FIG. 3). For example, a lightbulb may include a lidar sensor to scan the environment, such that the lightbulb then participates in the environment (e.g., serves as a provider of information, possibly for monetary value), without necessarily receiving information. The static agent (e.g., lidar sensor lightbulb) may generate revenue, which may or may not offset the cost for creating the map and the electricity used to operate the lightbulb. One or more embodiments may provide for a stand-alone static hardware agent (e.g., light, fire alarm, smoke detector, etc.) that may interface with block data in the block chains, and has the capability to provide sensor data for recordation in the secure, distributed ledger and receive credit for the provided data.

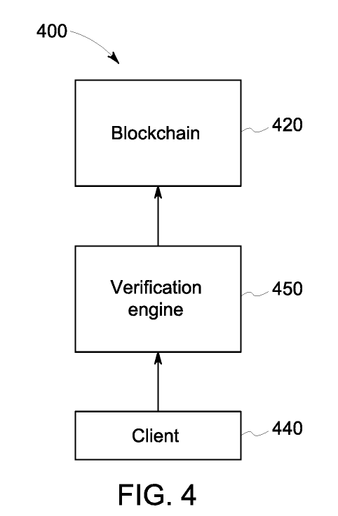

FIG. 4 is a system 400 implementing data sharing using blockchain validation according to some embodiments. According to some embodiments, the verification engine 450 and blockchain 420 may be used to provide transaction level verification for a client 440. Although FIG. 4 illustrates a system 400 with a single blockchain 420 and verification engine 450, note that embodiments may employ other topologies.

Although some embodiments are described using specific blockchain technologies, note that other approaches could be incorporated. For example, a Chainpoint platform for blockchains might be utilized to allow for the creation of a timestamp proof of the data and verify the existence and integrity of data stored in a blockchain. That is, a verification platform and the Chainpoint proof may be employed as a verification tool, rather than manually checking if the hashes match at a verification server.

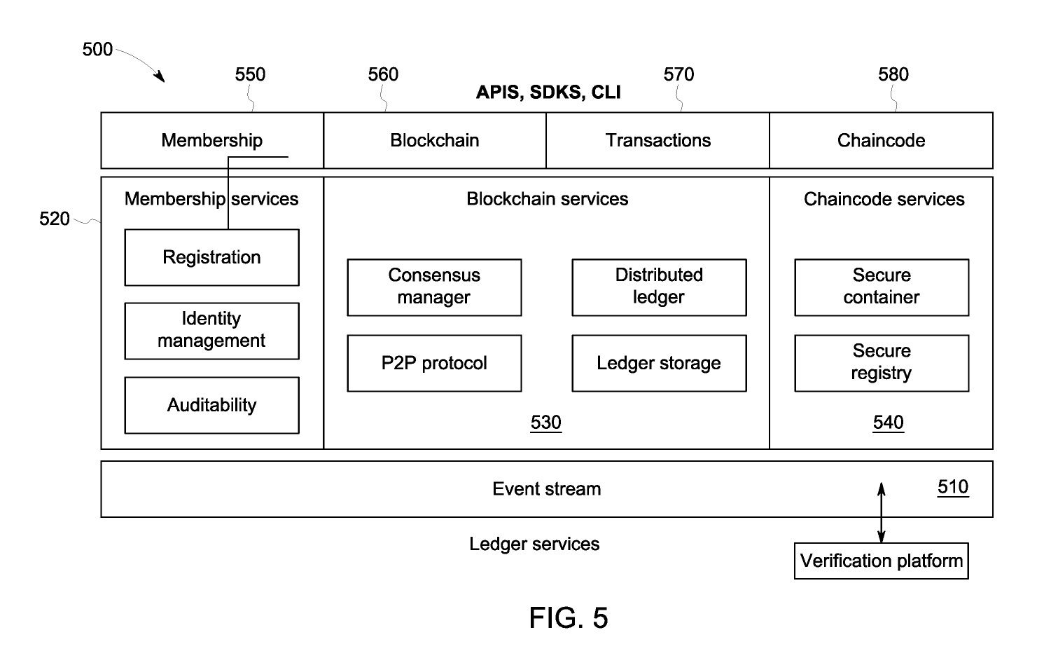

Embodiments may be associated with any type of distributed ledger having a de-centralized consensus-based network that supports smart contracts, digital assets, record repositories, and/or cryptographic security. For example, FIG. 5 is a distributed ledger reference architecture 500 that might be utilized by a data sharing platform according to some embodiments. The architecture 500 includes ledger services and an event stream 510 that may contain network security service information (e.g., from a digital transaction engine). Membership services 520 (e.g., including registration, identity managements, and/or an auditability process) may manage identity, privacy, and confidentially for membership 550 for the network security service. Blockchain services 530 (e.g., including a consensus manager, Peer-to-Peer (“P2P”) protocol, a distributed ledger, and/or ledger storage) may manage the distributed ledger through a P2P protocol built on HTTP to maintain a single state that is replicated at many nodes to support blockchains 560 and transactions 570. Chaincode services 540 (e.g., secure container and/or a secure registry associated with a smart contract) may help compartmentalize smart contract (or chaincode 580) execution on validating nodes. Note that the environment may be a “locked down” and secured container with a set of signed base images that contain a secure OS and programming languages. Finally, APIs, Software Development Kits (“SDKs”), and/or a Command Line Interface (“CLI”) may be utilized to support a network security service for a resource sharing platform via the reference architecture 500.

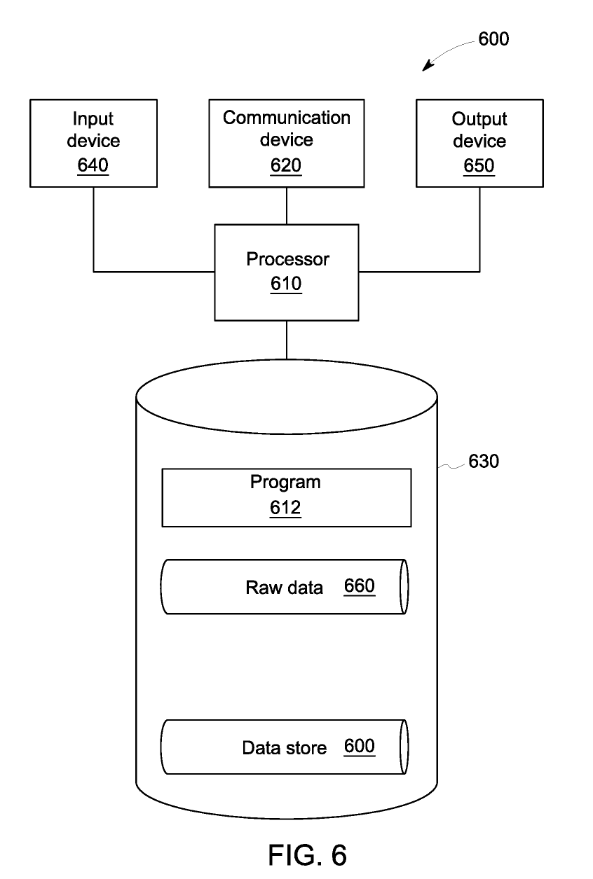

Embodiments described herein may comprise a tool that facilitates data sharing verification and may be implemented using any number of different hardware configurations. For example, FIG. 6 illustrates a data sharing platform 600 that may be, for example, associated with the system 100 of FIG. 1, (as well as other systems described herein). The platform 600 comprises a resource sharing processor 610, such as one or more commercially available Central Processing Units (“CPUs”) in the form of one-chip microprocessors, coupled to a communication device 620 configured to communicate via a communication network (not shown in FIG. 6). The communication device 620 may be used to communicate, for example, with one or more remote data stores, ledgers, etc. Note that communications exchanged via the communication device 620 may utilize security features, such as those between a public internet user and an internal network of an enterprise. The security features might be associated with, for example, web servers, firewalls, and/or PCI infrastructure. The platform 600 further includes an input device 640 (e.g., a mouse and/or keyboard to enter information about a distributed ledger, a data element, etc.) and an output device 650 (e.g., to output maps, AR displays, etc.).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or network security service tool or application for controlling the processor 610. The processor 610 performs instructions of the program 612, and thereby operates in accordance with any of the embodiments described herein. For example, the processor 610 may receive data about one or more data elements from another device. The processor 610 may then store the transformed data element and/or the common transformation in a data store 700. The processor 600 may record a hash value associated with the transformed data element in a secure, distributed ledger (e.g., associated with blockchain technology).

The program 612 may be stored in a compressed, uncompiled and/or encrypted format. The program 612 may furthermore include other program elements, such as an operating system, a database management system, and/or device drivers used by the processor 610 to interface with peripheral devices.

As used herein, information may be “received” by or “transmitted” to, for example: (i) the platform 600 from another device; or (ii) a software application or module within the platform 600 from another software application, module, or any other source.

In some embodiments (such as shown in FIG. 6), the storage device 630 further stores raw data 660 (e.g., data received from sensor or other devices) and the data store 700. The data may be stored in a database. Note, various databases might be split or combined in accordance with any of the embodiments described herein.

Thus, some embodiments described herein may have a technical advantage because the system includes decentralized and localized components (e.g., cloud/services, IoT, storage, payments). Every component may independently and dynamically offer its own services, making all services local. The local service may result in faster response time for rendered services, data transfer, etc. While embodiments may use a cloud/server, which is not decentralized, to help discover devices that are far apart, the information may typically be shared between locally discovered devices. Additionally, the devices may own their data, meaning there may be no need to create a centralized database. By the devices owning their own data, a load on cellular networks may be eliminated, since most of the data may be transferred directed. Another technical advantage may be with respect to resource sharing in that components may be dynamically configured to share resources. As the components share resources, no single component needs to be powerful. Further, as the resources are shared, the system may natively support parallel/distributed computing. Additionally, embodiments may be blockchain agnostic meaning that any type of blockchain can be used and the platform will still function. For example, when one blockchain is taking a very long time to confirm transactions, another (faster) blockchain may be swapped in to reduce confirmation times.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method comprising:
detecting, with a resource sharing module at a first Internet of Things (IoT) device, a second device;
determining one or more first data elements to transfer from the first IoT device to the second device;
determining one or more second data elements to transfer from the second device to the first IoT device;
transmitting the one or more first data elements from the first IoT device to the second device;
transmitting the one or more second data elements from the second device to the first IoT device;
establishing, between the first IoT device and the second device, a common transformation to apply to the one or more first and second data elements;
applying the common transformation to the one or more first and second data elements to generate a transformed data element; and
recording the common transformation via a secure, distributed transaction ledger.

2. The method of claim 1, wherein the IoT device is an Augmented Reality (AR) device.

3. The method of claim 2, wherein the secure, distributed transaction ledger comprises block chain technology.

4. The method of claim 3, further comprising:
issuing a block from the resource sharing module as part of a blockchain shared between the first AR device and the second device.

5. The method of claim 1, wherein the transformed one or more first and second data elements includes data about a specific geographic location.

6. The method of claim 1, wherein the one or more data elements is one of data and cryptocurrency.

7. The method of claim 1, wherein the first IoT device and the second device are co-located.

8. The method of claim 2, further comprising:
establishing encryption between the first AR device and the second device prior to determining the one or more first and second data elements.

9. The method of claim 2, wherein determining one or more first and second data elements to transfer further comprises:
broadcasting from the first AR device to the second device a message including one or more first data elements available from the first AR device;
in response to the broadcast, receiving at the first AR device, from the second device, a response message including one or more second data elements available from the second device; and
approving the first and second data elements.

10. The method of claim 2, wherein determining one or more first and second data elements to transfer further comprises:
broadcasting from the first AR device to the second device a request message for one or more second data elements;
in response to the broadcast, receiving at the first AR device, from the second device, a response message including one or more second data elements included in the request message and one or more first data elements requested by the second device; and
approving the first and second data elements.

11. A system comprising:
a resource sharing module;
a memory storing processor-executable steps; and
a resource sharing processor coupled to the memory, and in communication with the resource sharing module and operative to execute the processor-executable steps to cause the system to:
detect at a first Internet of Things (IoT) device, a second device;
determine one or more first data elements to transfer from the first IoT device to the second device;
determine one or more second data elements to transfer from the second device to the first IoT device;
transmit the one or more first data elements from the first IoT device to the second device;
transmit the one or more second data elements from the second device to the first IoT device;
establish, between the first IoT device and the second device, a common transformation to apply to the one or more first and second data elements;
apply the common transformation to the one or more first and second data elements to generate a transformed data element; and
record the common transformation via a secure, distributed transaction ledger.

12. The system of claim 1, wherein the IoT device is an Augmented Reality (AR) device.

13. The system of claim 12, wherein the secure, distributed transaction ledger comprises block chain technology.

14. The system of claim 13, further comprising processor-executable steps to cause the system to:
issue a block from the resource sharing module as part of a blockchain shared between the first AR device and the second device.

15. The system of claim 11, wherein the transformed one or more first and second data elements includes data about a specific geographic location.

16. The system of claim 11, wherein the first IoT device and the second device are co-located.

17. A non-transitory computer-readable medium storing program code, the program code executable by a computer system to cause the computer system to:
detect at a first Augmented Reality (AR) device, a second device;
determine one or more first data elements to transfer from the first AR device to the second device;
determine one or more second data elements to transfer from the second device to the first AR device;
transmit the one or more first data elements from the first AR device to the second device;
transmit the one or more second data elements from the second device to the first AR device;
establish, between the first AR device and the second device, a common transformation to apply to the one or more first and second data elements;
apply the common transformation to the one or more first and second data elements to generate a transformed data element; and
record the common transformation via a secure, distributed transaction ledger.

18. The medium of claim 17, further comprising program code to cause the system to:
establish encryption between the first AR device and the second device prior to determining the one or more first and second data elements.

19. The medium of claim 17, wherein determining one or more first and second data elements to transfer further comprises program code to cause the system to:
broadcast from the first AR device to the second device a message including one or more first data elements available from the first AR device;
in response to the broadcast, receive at the first AR device, from the second device, a response message including one or more second data elements available from the second device; and
approve the first and second data elements.

20. The medium of claim 17, wherein determining one or more first and second data elements to transfer further comprises program code to cause the system to:
broadcast from the first AR device to the second device a request message for one or more second data elements;
in response to the broadcast, receive at the first AR device, from the second device, a response message including one or more second data elements included in the request message and one or more first data elements requested by the second device; and
approve the first and second data elements.
